(19) United States
(12) Patent Application Publication
(10) Pub. No.: US 2022/0129649 A1
(43) Pub. Date: Apr. 28, 2022

(54) Amusement ride and method for operating an amusement ride

(71) Applicant: MACK RIDES GMBH & CO. KG, Waldkirch (DE)

(72) Inventors: Andreas FRIEDBERGER, Waldkirch (DE); Rudolf FLEIG, Freiburg (DE); Jan-Philip ENDERLE, Gengenbach (DE)

(21) Appl. No.: 17/429,809

(22) PCT Filed: Jan. 17, 2020
(86) PCT No.: PCT/EP2020/051106

§ 371 Date: Aug. 10, 2021

(30) Foreign Application Priority Data
Feb. 11, 2019 (CN) 201910109888.5
Feb. 11, 2019 (DE) 10 2019 103 301.2

(51) Int. Cl. G06K 7/10; A63G 4/00; G01G 19/12; G01G 23/37; G01K 1/024; A63G 7/00

(52) U.S. Cl. CPC G06K 7/10366; A63G 4/00; G01G 19/12; A63G 1/10; G01K 1/024; A63G 7/00; G01G 23/3728

(57) ABSTRACT

The present invention relates to an amusement ride (1) comprising at least one vehicle (2) which can move along a specified track (10), wherein the at least one vehicle (2) comprises at least one sensor (30), wherein the at least one sensor (30) is electrically independent of the vehicle (2), wherein the at least one sensor (30) comprises an RFID transponder (35), and wherein at least one RFID receiver (20) is arranged along the specified track (10), which is set up to communicate with the RFID transponder (35) and to read out the at least one measured value from the at least one sensor (30).

The present invention relates to an amusement ride with the features of patent claim 1 and a method for operating such an amusement ride with the features of patent claim 14.

Amusement rides are known from prior art in different designs. Amusement rides typically include at least one vehicle, which is set up to travel along a specified track and to transport a number of passengers for entertainment purposes. To this end, the vehicles can have a plurality of seats on which passengers are intended to take a seat for the journey on the amusement ride and are kept secured on the seats by suitable safety measures during the journey. Such amusement rides can be, for example, a roller coaster, a water ride, a carousel, or a swing, which all have in common that the vehicle comes to a standstill at a predetermined position after a journey to allow the passengers to get on or off.

Amusement rides are continuously being developed further, wherein developments in recent years have been pursued in particular with regard to traveling through spectacular ride elements at higher speeds and greater accelerations, with large forces acting both on the vehicles and on a guide track that specifies the course along the specified track. In order to ensure the long-term safety of the passengers, modern amusement ride vehicles have complex monitoring technology with a plurality of sensors, which are set up to detect mechanical loads and wear on the vehicles by means of a suitable sensor system, in order to inform the operator of the amusement ride of necessary maintenance and repair activities in good time before critical loads are reached.

The use of a plurality of sensors on the vehicles of amusement rides is known from prior art. However, it has proved to be disadvantageous that the sensors for data acquisition require a high outlay, in particular in the instrumentation of hardware on the vehicles. The sensors of the vehicle are energized by means of an integrated energy supply carried by the vehicle. Central cabling is also provided, by means of which the sensors are supplied with electrical energy on the one hand and by means of which data is transmitted for central data acquisition on the other hand. The energy supply is often provided by means of electrical storage media, for example batteries or rechargeable batteries, which are recharged when the vehicle is at a standstill, for example during the night rest periods. Furthermore, it has been found to be disadvantageous that, in addition to the complex installation of hardware, such sensors and data acquisition make the overall system unnecessarily heavy, as a result of which larger forces are required for the realization of large accelerations.

This is where the present invention begins.

It is the object of the present invention to propose an amusement ride that improves amusement rides known from prior art in an expedient manner by means of sensors, wherein, on the one hand, the effort involved in the hardware installation or instrumentation of the sensors and data acquisition is to be reduced and, on the other hand, the weight on a vehicle is to be reduced in order to be able to realize large accelerations of the amusement ride with the same or lower forces.

These objects are solved by means of an amusement ride with the features of patent claim 1, by the use of at least one sensor in an amusement ride with the features of patent claim 13 and a method for operating an amusement ride with the features of patent claim 14.

Further advantageous embodiments of the invention are specified in the dependent claims.

The amusement ride according to the invention with the features of patent claim 1 comprises at least one vehicle which can move along a specified track. The at least one vehicle further comprises at least one sensor, wherein the at least one sensor is electrically independent of the vehicle. In connection with this invention, electrically independent can be understood to mean a complete electrical decoupling of the at least one sensor from the vehicle. The at least one sensor is not dependent on an electrical energy supply of the particular vehicle, nor is it coupled with a central data processing system arranged in the vehicle, through which the detected signals are processed, stored, evaluated, or continued to slide. Furthermore, according to the invention, it is provided that the at least one sensor comprises a transponder, in particular an RFID transponder, and that at least one receiver, in particular an RFID receiver, is arranged along the specified track, which is set up to communicate with the RFID transponder of the at least one sensor and to read out at least one measured value from the at least one sensor. Each sensor can comprise a sensor system, which is set up to detect at least one physical measured variable. The at least one receiver can either read out the data from the transponder or, alternatively, transmit data to the transponder. In connection with this invention, a transponder and a receiver can communicate with one another at any desired frequency, wherein different ISM frequency bands have proven themselves for this purpose and are approved for the use of wireless data transmission throughout Europe and internationally. The different wavelengths are suitable for different transmission rates and transmission distances, wherein, for example, the long waves with a frequency range between 30 and 500 kHz are suitable for large radio ranges at a low data rate, while the short waves, or in particular microwaves, are only suitable for short transmission distances, but enable the transmission of large data rates, in particular in a short time. It is therefore particularly preferred that the transponder and the receiver use high frequencies (HF) or very high frequencies (UHF) and in particular microwaves of up to 6 GHz, whereby a sufficient data transmission between the transponder and the receiver can take place even in the case of very fast traveling of the vehicle past the at least one receiver.

The at least one RFID receiver is arranged adjacent to the specified track for the at least one vehicle, so that when the at least one vehicle travels past the at least one RFID receiver, the sensor and the associated RFID transponder are located within a data transmission range or within the maximum radio range of the RFID receiver or of the RFID transponder. When the at least one vehicle travels past the at least one receiver, the receiver sends a query signal to the transponder. By means of the query signal, a coil of the transponder is charged as a receiving antenna by induction and the induced voltage makes it possible to carry out at least one measurement and to detect at least one measured value. The transponder then sends a response of the query signal to the receiver.

According to a further embodiment of the present invention, it is advantageous if the at least one sensor is a digital or an analog sensor. In particular, it is preferred for the at least one sensor to comprise one or more A/D converters, which are set up to convert analog signals of the sensor system into a digital signal. Furthermore, it is preferred if the at least one sensor does not have its own voltage source, in particular no battery, rechargeable battery, or the like, and is exclusively supplied with energy by the transponder, in particular the RFID transponder.

Furthermore, it is particularly advantageous if the at least one sensor monitors a mechanical secondary system. Such a secondary system can be, for example, the safety system, a holding bracket, or a belt for the at least one passenger on the at least one seat. The safety system, the holding bracket or the belt keep the passenger secured in the seat while riding on the amusement ride. The at least one sensor can detect a correct securing. Furthermore, the at least one sensor can monitor a coupling between two adjacent vehicles, or another mechanical system on the vehicle. The at least one sensor can also monitor a mechanical secondary system for increasing the safety of an amusement ride, as is known from DE 10 2014 114 338 A1. The at least one mechanical sensor can, for example, detect the acceptance of a mechanical load by a redundant component or detect the drop of the load-bearing capacity of a primary component.

A further advantageous embodiment of the present invention provides that the at least one sensor comprises passenger identification. The capacity of the at least one vehicle can be determined by means of passenger identification.

Furthermore, it is advantageous if the at least one sensor detects a passenger's weight in a space or on a seat in the at least one vehicle. Furthermore, it is advantageous if the passenger weight is measured by means of an analog resistance sensor, which is distinguished by the fact that it is particularly inexpensive and, moreover, robust.

Furthermore, it has proved to be advantageous if the at least one sensor detects wheel wear of at least one wheel of the at least one vehicle. Such sensors are particularly inexpensive and robust and can be arranged either directly on the wheel or adjacent to the wheel without the need for complex cabling with central data acquisition. In particular, when using the sensors, it is possible to dispense with the elaborate installation of slip rings or the like in order to transmit electrical signals from a rotating component or system to a stationary component.

A further advantageous embodiment of the present invention provides that the at least one sensor detects a bearing temperature of at least one bearing of the at least one vehicle. The at least one sensor can include, for example, a resistance thermometer or a thermocouple.

Furthermore, it may be advantageous if the at least one sensor is used as a tracking sensor and does not detect a measured value. The at least one RFID receiver can locate or track the at least one tracking sensor, whereby the position of the at least one monitored component of the vehicle can be detected. For example, the position of a safety bar or a belt can be detected by means of the tracking sensor.

The RFID transponder can also be an active, semi-passive or a semi-active transponder. While active RFID transponders use the induced voltage both for the energy supply of the microchip and for the generation of a queried feedback signal, semi-passive or semi-active transponders do not have their own transmitter, but moderate backscatter, which makes them significantly more energy-efficient.

In accordance with a further advantageous embodiment of the present invention, it is provided that the at least one sensor and/or the RFID transponder has/have a current storage device. In particular, it is preferred if the voltage induced by a query signal of the at least one RFID receiver is sufficiently large to charge a current storage device. A plurality of measurements can be carried out by means of the current storage device. The current storage device preferably comprises at least one capacitor circuit, which is charged by means of the query signal when the at least one vehicle travels past the receiver. It is advantageous if the induced voltage charges the current storage device to such an extent that each sensor is energized even outside the radio range of the RFID transponder until the vehicle again travels past an RFID receiver along the specified path.

A further preferred embodiment of the present invention provides that the at least one sensor and/or the RFID transponder has/have a data memory. The data memory can also be powered by the current storage device outside the radio range of the RFID receiver and one or more measured values can be stored on the data memory. In response to a query signal of the at least one RFID receiver, the RFID transponder can transmit the measured values stored on the data memory to the RFID receiver.

According to a further advantageous embodiment of the present invention, it is provided that the amusement ride is a circular ride with a closed track. Such a circular ride is preferably a roller coaster or a water roller coaster, but also a rotating carousel and the like. Furthermore, it is advantageous if the amusement ride is a shuttle ride, wherein the at least one vehicle on the track travels on the track alternately in different directions. Such a shuttle ride can have a track with a first end and a second end, the at least one vehicle traveling back and forth between the two ends. Such a shuttle ride can be, for example, the so-called “PowerSplash”. Such an amusement ride can also be a swing or the like.

A further aspect of the present invention relates to the use of a sensor in an amusement ride or on an amusement ride vehicle. The sensor comprises at least one RFID transponder and at least one sensor system, which is set up to detect at least one physical measured value and to provide the at least one physical measured value for the RFID transponder for transmission to an RFID receiver.

A further aspect of the present invention relates to a method for operating an amusement ride, wherein according to the invention it is provided that at least one query signal is sent by the at least one RFID receiver when the at least one vehicle travels past the at least one RFID receiver. Each RFID transponder receives the at least one query signal and at least one measured value is detected by the at least one sensor. Subsequently, the at least one measured value is transmitted by the RFID transponder of the at least one sensor to the at least one RFID receiver, and at least one status of the at least one vehicle is determined on the basis of the at least one measured value. When the at least one vehicle travels past the at least one RFID receiver, the RFID transponder of the at least one sensor is within radio range and the RFID receiver and the RFID transponder can communicate with one another.

Furthermore, it is advantageous if, when the at least one vehicle travels past the RFID receiver, the query signal in the RFID transponder induces a current and the at least one sensor is energized by the induced current and detects the at least one measured value. The at least one sensor can thus be arranged electrically independent of the at least one vehicle on the at least one vehicle, as a result of which, on the one hand, no electrical coupling of the at least one sensor to the vehicle is necessary and, on the other hand, existing vehicles can also be retrofitted with corresponding sensors.

The at least one status can indicate, for example, the capacity of the vehicle of the amusement ride, or the weight of the passengers, for example in order to accelerate the at least one vehicle to a predetermined speed with a predetermined force. The at least one status can also describe the mechanical status of the at least one vehicle in order to detect wear, abrasion, or the like.

Furthermore, it is particularly advantageous if, when traveling past the at least one RFID receiver, a current storage device of the at least one sensor is charged by means of the query signal of the at least one RFID receiver. The current storage device preferably comprises at least one capacitor circuit, which is set up to store a current induced in the RFID transponder and to deliver it when required. By means of the current stored in the current storage device, each sensor can also be energized outside the transmission distance.

In particular, it is preferred if the current storage device of the at least one sensor energizes the sensor between two journeys of the at least one vehicle past the at least one RFID receiver, as a result of which the at least one sensor with its sensor system can also record measured values outside the radio range.

According to a further advantageous embodiment of the present invention, it is advantageous if, in carrying out the method according to the invention, the at least one sensor detects at least one measured value and writes the at least one measured value to a data memory between the two journeys past. Furthermore, it is preferred that, when traveling past the at least one RFID receiver, the at least one measured value stored on the data memory is transmitted from the RFID transponder of each sensor to the RFID receiver. By storing the electrical energy, measured values can preferably also be detected outside the radio range of the RFID receiver and the RFID transponder by means of the at least one sensor and stored in a data memory. As soon as the vehicle with the at least one sensor travels past the at least one RFID receiver again and is within the radio range of the at least one RFID receiver, the measured values can be transmitted in response to a query signal and the current storage device can be recharged.

An exemplary embodiment according to the invention is explained in detail below with reference to the accompanying drawing.

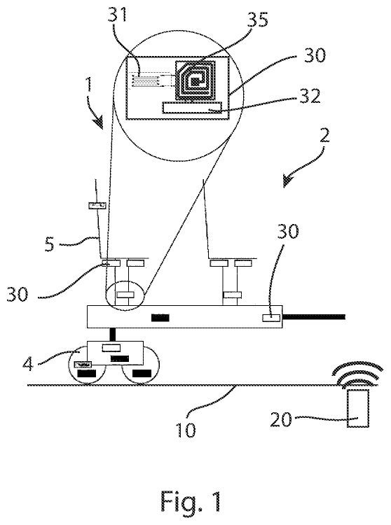

FIG. 1 shows a greatly simplified vehicle 2 of an amusement ride 1, which is set up to travel on a specified track 10 of the amusement ride 1. The amusement ride 1 can be, for example, a roller coaster or a water ride, for example a so-called “PowerSplash”, wherein the track 10 can be formed from one or more guide rails, through which the vehicle 2 is guided along the specified track 10 by means of a plurality of wheels 4. Furthermore, the vehicle 2 comprises a plurality of seats 5, on which passengers (not shown) are intended to take a seat for a journey with the amusement ride 1.

At least one RFID receiver 20 is arranged along the specified track 10, wherein a plurality of RFID receivers 20 can also be arranged along the track 10. Each RFID receiver 20 is arranged adjacent to the track 10, so that the vehicle 2 traveling past on the track 10 is located within the radio range of the RFID receiver 20.

The RFID receivers 20 can be arranged, for example, in such a way that the travel time of the vehicle 2 between two adjacent RFID receivers 20 is approximately the same length. Alternatively, the RFID receivers 20 can be arranged on sections or ride elements of the track 10 in which there are increased loads on the vehicle 2 due to accelerations.

The vehicle 2 comprises a plurality of sensors 30, each of which can comprise at least one RFID transponder 35 and at least one sensor system 31. Each sensor 30 is electrically independent of the vehicle 2, i.e., completely electrically decoupled from the vehicle. In FIG. 1, the sensors 30 are indicated by way of example by squares, wherein not every sensor 30 is marked with a reference number for reasons of clarity.

The sensor system 31 is set up to measure at least one physical quantity. Furthermore, each sensor 30 can comprise a data memory 32 and a current storage device 34 (not shown), which comprises, for example, at least one capacitor circuit. The RFID transponder 35 is set up to communicate with the RFID receiver 20 within a radio range, which is typically in the range of a few meters to a few centimeters.

When the vehicle 2 travels past the at least one RFID receiver 20, the vehicle 2 moves into the radio range of the RFID receiver 20 and the RFID receiver 20 sends one or more query signals and induces a voltage in the RFID transponder 35 of each sensor 30. The voltage can, for example, charge the capacitor circuit and be used for carrying out a measurement with the sensor 30 or its sensor system 31. The RFID transponder 35 can then send a response of the query signal to the RFID receiver 20.

Each sensor 30 can be a digital or analog sensor and the sensor system 31 can comprise a plurality of different measurement techniques, which are designed to describe a physical status of the at least one vehicle 2. For example, the sensor system 31 can comprise a thermocouple, a resistance thermometer, a strain gauge (as shown schematically), a measurement contact etc.

The sensor 30 can be suitable, for example, by its sensor system 31, to determine or detect wear of one of the wheels 4 of the vehicle 2, to detect a passenger on the seat 5 or to monitor secondary systems. The sensor 30 can also be used for component tracking.

In addition, a sensor 30 may be suitable for detecting the passenger weight on a seat 5 on the vehicle 2. For this purpose, one or more resistance sensors can be arranged on the seat 5, by means of which the weight of the passenger can be determined. A plurality of sensors 30 can also be arranged on the vehicle 2, which detect, for example, the screw torque of screws, which ensures that safety-relevant screw connections are always properly tightened.

Furthermore, sensors 30 can be arranged on the axles of the wheels 4 or on the bearings of the axles of the wheels 4, by means of which the bearing temperature can be detected. When using the sensors 30, it is particularly advantageous that no cabling has to be carried out in the vehicle 2, and thus complicated transmission paths, for example by means of slip rings or the like, are superfluous.

Each sensor 30 can comprise a memory 32. One or more measured values can be stored or temporarily stored in the memory 32, which are transmitted by the RFID transponder 35 to the RFID receiver 20 in response to a query signal.

The current storage device 34 can be charged in response to a query signal from the RFID receiver 20 and can energize the sensor 30 outside the radio range of the RFID receiver 20, as a result of which measured values which can be temporarily stored in the memory 32 can also be recorded outside the radio range.

### LIST OF REFERENCE NUMERALS

1 Amusement ride
2 Vehicle
4 Wheels
5 Seat
10 Track
20 Receiver
30 Sensor
32 Memory
35 Transponder

1. An amusement ride (1), comprising:
at least one vehicle (2) which can move along a specified track (10),
wherein the at least one vehicle (2) comprises at least one sensor (30),
wherein the at least one sensor (30) is electrically independent of the vehicle (2),
wherein the at least one sensor (30) comprises an RFID transponder (35),
wherein at least one RFID receiver (20) is arranged along the specified track (10), which is set up to communicate with the RFID transponder (35) and to read out the at least one measured value from the at least one sensor (30).

2. The amusement ride (1) according to claim 1, characterized in that the at least one sensor (30) is a digital sensor or an analog sensor.

3. The amusement ride (1) according to claim 1, characterized in that the at least one sensor (30) monitors a mechanical secondary system.

4. The amusement ride (1) according to claim 1, characterized in that the at least one sensor (30) comprises passenger identification.

5. The amusement ride (1) according claim 1, characterized in that the at least one sensor (30) records a passenger weight of a passenger in a space (5) in the at least one vehicle (2).

6. The amusement ride (1) according to claim 1, characterized in that the at least one sensor (30) detects wheel wear of at least one wheel (4) of the at least one vehicle (2).

7. The amusement ride (1) according to claim 1, characterized in that the at least one sensor (30) detects a bearing temperature of at least one bearing of the at least one vehicle (2).

8. The amusement ride (1) according to claim 1, characterized in that the at least one sensor (30) is a tracking sensor and that the at least one RFID receiver (20) locates or tracks at least one component of the at least one vehicle (2).

9. The amusement ride (1) according to claim 1, characterized in that the RFID transponder (30) is a passive, semi-passive or semi-active RFID transponder (30).

10. The amusement ride (1) according to claim 1, characterized in that the sensor (30) and/or the RFID transponder (35) has a data memory (32).

11. The amusement ride (1) according to claim 1, characterized in that the at least one sensor (30) has a current storage device (34).

12. The amusement ride (1) according claim 1, characterized in that the amusement ride (1) is a circular ride with a track (10) closed in a circle, or that the amusement ride (1) is a shuttle ride, wherein the at least one vehicle travels alternately back and forth on the track (10).

13. A use of the sensor (30) in the amusement ride (1) according to claim 1.

14. A method for operating the amusement ride (1) according to claim 1, comprising the following method steps:
sending at least one query signal by means of the at least one RFID receiver (20) when the at least one vehicle (2) travels past the at least one RFID receiver (20),
recording at least one measured value by means of the at least one sensor (30),
transmitting at least one measured value to the RFID receiver (20) by means of the RFID transponder (35), and
determining at least one status of the least one vehicle (2) on the basis of the at least one measured value.

15. The method according to claim 14, characterized in that a current storage device (34) of the at least one sensor (30) is charged when traveling past the at least one RFID receiver (20).

16. The method according to claim 15, characterized in that the current storage device (34) of the at least one sensor (30) energizes the at least one sensor (30) between two journeys past the at least one RFID receiver (20).

17. The method according to claim 14, characterized in that the at least one sensor (30) writes at least one measured value to a data memory (32) between the two journeys past.
